(19) United States
(12) Patent Application Publication
(10) Pub. No.: US 2026/0296108 A1
(43) Pub. Date: Oct. 1, 2026

(54) Optimized Architecture of a Tire of the Heavy Duty or Civil Engineering Type

(71) Applicant: COMPAGNIE GENERALE DES ESTABLISHMENTS MICHELIN, Clermont-Ferrand (FR)

(72) Inventor: Vincent ESTENNE, Clermont-Ferrand Cedex 9 (FR)

(21) Appl. No.: 18/877,542

(22) PCT Filed: Jun. 1, 2023
(86) PCT No.: PCT/EP2023/065756

§ 371 Date: Dec. 20, 2024

(30) Foreign Application Priority Data
Jun. 20, 2022 (FR) FR2206021

(51) Int. Cl. B60C 9/20

(52) U.S. Cl. CPC B60C 9/2003; B60C 2009/2016; B60C 2009/2019; B60C 2009/209; B60C 2200/065

(57) ABSTRACT

A radial tire for a heavy-duty or civil engineering vehicle having two working layers (51, 52) with metal reinforcing elements forming an angle at least equal to 15° and at most equal to 45° with the circumferential direction (XX′), and at least one hooping layer (41, 42). Each hooping layer has metal reinforcing elements (411) forming, with the circumferential direction (XX′), an angle A that can vary depending on the axial position. The angles Ae1, Ae2 at the two axial ends (412, 413) of the hooping layer (41, 42) are of the same orientation and have absolute values at most equal to 10°. The angle A has a maximum absolute value Am at an axial distance from the median plane (M) at most equal to 15% of the axial width of said hooping layer, Am being at least equal to the mean of the absolute values of the angles Ae1, Ae2 plus 10°.

The present invention relates to a radial tire intended to be fitted to a heavy-duty or civil engineering vehicle, and more particularly concerns the crown reinforcement of such a tire.

Radial tires intended to be fitted to a heavy-duty or civil engineering vehicle are designated within the meaning of the European Tire and Rim Technical Organisation, or ERTRO, standard.

For example, a radial tire for a heavy-duty civil engineering vehicle, within the meaning of the European Tire and Rim Technical Organisation, or ETRTO, standard, is intended to be mounted on a rim with a diameter at least equal to 25 inches. Although not limited to this type of application, the invention is described for a radial tire with large dimensions intended to be mounted on a dumper, in particular on vehicles for transporting materials extracted from quarries or surface mines, by means of a rim with a diameter at least equal to 35 inches, possibly as much as 57 inches, or even 63 inches. The heavy-duty tires in question are intended to be mounted on a rim with a diameter at least equal to 19.5 inches.

Since a tire has a geometry which exhibits symmetry of revolution about an axis of rotation, the geometry of the tire is generally described in a meridian plane containing the axis of rotation of the tire. For a given meridian plane, the radial, axial and circumferential directions respectively denote the directions perpendicular to the axis of rotation of the tire, parallel to the axis of rotation of the tire, and perpendicular to the meridian plane. The circumferential direction is tangential to the circumference of the tire.

Hereinafter, the expressions “radially inside” and “radially outside” respectively mean “closer to” and “further away from the axis of rotation of the tire”. “Axially inside” and “axially outside” respectively mean “closer to” and “further away from the equatorial plane of the tire”, the equatorial plane of the tire being the plane passing through the middle of the tread surface and perpendicular to the axis of rotation. “An element A axially inside an element B by an axial distance D” is given to mean that the element A is closer to the equatorial plane than the element B and that the axial distance between the two elements is equal to the distance D. This type of sentence can be generalized to the radial and circumferential directions and the outside versus inside position of one or the other of the elements.

Generally, a tire comprises a tread intended to come into contact with the ground by means of a tread surface, the two axial ends of which are connected by means of two sidewalls to two beads that provide the mechanical connection between the tire and the rim on which it is intended to be mounted.

A radial tire further comprises a strengthening reinforcement made up of a crown reinforcement radially inside the tread, and a carcass reinforcement radially inside the crown reinforcement.

The carcass reinforcement of a radial tire for a civil engineering or heavy-duty vehicle usually comprises at least one carcass layer comprising metal reinforcers that are coated in a polymeric material of the elastomer or elastomeric type obtained by blending and known as a coating compound. A carcass layer comprises a main part that connects the two beads together and is generally wound, in each bead, from the inside of the tire to the outside around a usually metal circumferential reinforcing element known as a bead wire so as to form a turn-up. The metal reinforcers of a carcass layer are substantially parallel to each other and form an angle of between 85° and 95° with the circumferential direction.

The crown reinforcement of a radial tire for a heavy-duty or civil engineering vehicle comprises a superposition of crown layers extending circumferentially, radially outside the carcass reinforcement. Each crown layer is made up of generally metal reinforcers that are parallel to each other and coated in a polymeric material of the elastomer or coating compound type.

A metal reinforcer is mechanically characterized by a curve representing the tensile force (in N) applied to the metal reinforcer as a function of the relative elongation (as a %) thereof, known as the force-elongation curve. Mechanical tensile characteristics of the metal reinforcer, such as the structural elongation As (as a %), the total elongation at break At (as a %), the force at break Fm (maximum load in N) and the breaking strength Rm (in MPa), are derived from this force-elongation curve, these characteristics being measured in accordance with ASTM D 2969-04 of 2014.

The total elongation At of the metal reinforcer is, by definition, the sum of its structural, elastic and plastic elongations (At=As+Ae+Ap) and particularly at break, when each of the elongations is non-zero. The structural elongation As results from the relative positioning of the metal threads making up the metal reinforcer under a low tensile force. The elastic elongation Ae results from the actual elasticity of the metal of the metal threads making up the metal reinforcer, taken individually, the behavior of the metal following Hooke's law. The plastic elongation Ap results from the plasticity, that is the irreversible deformation beyond the elastic limit, of the metal of these metal threads taken individually. These different elongations and the respective meanings thereof, which are well known to a person skilled in the art, are described, for example, in U.S. Pat. No. 5,843,583, WO2005/014925 and WO2007/090603.

Also defined, at any point on the force-elongation curve of a metal reinforcer, is a tensile modulus, expressed in GPa, which represents the gradient of the straight line tangential to the force-elongation curve at this point. In particular, the tensile modulus of the elastic linear part of the force-elongation curve is referred to as the tensile elastic modulus or Young's modulus.

Among the metal reinforcers, a distinction is usually made between elastic metal reinforcers, such as those used in the protective layers, and non-extensible or inextensible metal reinforcers.

An elastic metal reinforcer, in its rubberized state extracted from the tire, is characterized by a structural elongation As at least equal to 0.3% and a total elongation at break At at least equal to 2.5%. In addition, an elastic metal reinforcer has a tensile elastic modulus at most equal to 150 GPa, and usually between 40 GPa and 130 GPa.

An inextensible metal reinforcer is characterized by a total elongation At, under a tensile force equal to 10% of the force at break Fm, at most equal to 0.3%. Moreover, an inextensible metal reinforcer has a tensile elastic modulus usually between 150 GPa and 200 GPa.

Among the crown layers, a distinction is usually made between the protective layers, which make up the protective reinforcement and are radially outermost, comprising elastic reinforcing elements (or reinforcers), and the working layers comprising inextensible reinforcing elements, which make up the working reinforcement and are radially between the protective reinforcement and the carcass reinforcement.

The protective reinforcement, comprising at least one protective layer, essentially protects the working layers from mechanical or physicochemical attack that might spread through the tread radially towards the inside of the tire.

The protective reinforcement often comprises, for a civil engineering tire, two radially superposed protective layers formed of elastic metal reinforcers that are parallel to each other in each layer and crossed from one layer to the next, forming angles at least equal to 15° with the circumferential direction, and often a single protective layer for a heavy-duty tire.

The working reinforcement, comprising at least two working layers, has the function of belting the tire and conferring stiffness and road holding thereon. It absorbs both mechanical stresses of inflation, which are generated by the tire inflation pressure and transmitted by the carcass reinforcement, and mechanical stresses caused by running, which are generated as the tire runs over the ground and are transmitted by the tread. It also needs to withstand oxidation, impacts and puncturing, due to its intrinsic design and the design of the protective reinforcement.

The working reinforcement usually comprises two radially superposed working layers formed of inextensible metal reinforcers that are parallel to each other in each layer and crossed from one layer to the next, forming angles at most equal to 60°, and preferably at least equal to 15° and at most equal to 45°, with the circumferential direction. To reduce the shearing of the rubber compounds, or rubber mixtures, at the axial ends of the working layers, it is usual to axially offset the position of said ends relative to one another. The crown reinforcement therefore usually comprises a working layer having a larger axial width and a working layer having a smaller axial width. The shearing of the rubber compounds is maximum at the end of the working layer having a smaller axial width. This maximum shearing due to the displacement of the end of the working layer having a smaller axial width is distributed over the radial thickness of rubber compounds between the working layer having a smaller axial width and the working layer having a larger axial width. This shearing is amplified by the deformation of the working layer having a larger axial width. Given the angle of the metal reinforcers crossed with the metal reinforcers of the working layer having a smaller width, the working layer having a larger axial width deforms in another direction, which increases the deformation of the rubber compounds. This maximum shearing is generally reduced by adding a decoupling rubber between the end of the working layer having a smaller axial width and the working layer having a larger axial width. The end of the working layer having a larger axial width is also subject to significant shearing but generally of lesser amplitude given that for this end, the thickness of the rubber compounds is greater and the deformation is no longer amplified by the presence of the other working layer.

In order to reduce the mechanical inflation and running stresses that are transmitted to the working reinforcement and the shearing of the rubber mixture covering it, it is known practice to position a hoop reinforcement radially outside the carcass reinforcement. The hoop reinforcement, the function of which is to at least partially absorb the mechanical stresses of inflation, improves the endurance of the crown reinforcement by stiffening the crown reinforcement. The hoop reinforcement can be positioned radially inside the working reinforcement, between the two working layers of the working reinforcement, or radially outside the working reinforcement.

In heavy-duty applications, the hoop reinforcement often comprises a hooping layer formed by the winding of a reinforcing element.

In civil engineering applications, the hoop reinforcement can comprise two radially superposed hooping layers formed of metal reinforcers, parallel to each other in each layer and crossed from one layer to the next, forming angles at most equal to 10° with the circumferential direction. In order to produce the hooping layers, on large-diameter civil engineering tires, the winding of a layer of discontinuous reinforcing elements the ends of which extend from one axial edge of the layer to the other, forming an angle of between 7 and 9° with the circumferential direction, is often preferred to the winding of a narrow strip of several continuous reinforcing elements forming an angle of between 0° and 5° with the circumferential direction, for reasons of productivity. In both cases, the hooping layers have a smaller axial width than the working layer having a smaller axial width. The stresses due to running at the end of the working layers are very high in tension and compression and lead to the breakage of the inextensible metal reinforcers arranged around the ends that form angles of less than 15° with the circumferential direction. WO2019/202239 discloses a usual architecture of civil engineering tires comprising two hooping layers of rigid reinforcing elements, radially inside two working layers of rigid reinforcing elements radially inside elastic protective layers, the two hooping layers having a substantially smaller axial width than the axial width of the working layers. This document discloses the optimization of the protective layers in order to improve the resistance to attacks on the crown to which civil engineering tires are subject. Civil engineering tires, and particularly those used in surface mines, are subject to attacks generally in the vicinity of the working face where the ore protrudes more. As the tread wears, the impact of the indentation stiffness of the crown block on cuts in the tread is felt. Although the optimization proposed in the prior art has its benefits, the significant circumferential stiffness thereof, mainly provided by the hooping layers and mostly at the center of the crown, promotes cuts in the tread and the uneven wear thereof at the center, and sometimes the complete puncturing of the crown block. It is well known to a person skilled in the art that increasing the mean angle of the hooping layers to above 15° makes it possible to reduce the stiffness of the crown, but this accordingly reduces endurance by promoting cracks at the ends of the working layers, and also at the end of the hooping layers themselves.

These crown attack problems also occur, but to a lesser extent, for heavy-duty tires, with crown attack resulting more in the chunking of the tread than in wear.

The inventors aimed to retain satisfactory endurance, particularly at the ends of the crown layers, and improve puncture resistance by reducing the circumferential stiffness at the center while retaining effective hooping action for a civil engineering or heavy-duty tire, and to improve resistance to wear due to attack for civil engineering tires.

This objective has been achieved, according to the invention, by a radial tire for a heavy-duty or civil engineering vehicle comprising
a crown reinforcement, radially radial tire for a heavy-duty or civil engineering vehicle comprising
a crown reinforcement, radially inside a tread and radially outside a carcass reinforcement,
a median plane perpendicular to the axis of rotation of the tire and passing through the middle of the tread,
the crown reinforcement comprising a working reinforcement,
the working reinforcement comprising at least two working layers, each comprising metal reinforcing elements coated in an elastomeric material that are parallel to each other, forming an angle at least equal to 15° and at most equal to 45° with the circumferential direction (XX′), said metal reinforcing elements being crossed from one working layer to the next,
the crown reinforcement comprising a hoop reinforcement comprising at least one hooping layer, each hooping layer comprising metal reinforcing elements coated in an elastomeric material, parallel to each other and comprising two axial ends on either side of the median plane,
the reinforcing elements of each hooping layer forming, at the two axial ends thereof, angles of the same orientation and having absolute values at most equal to 10° with the circumferential direction,
the angle formed by the metal reinforcing elements of a hooping layer with the circumferential direction (XX′) being variable from one axial end of said hooping layer to the other axial end, and having a maximum absolute value at an axial distance from the median plane at most equal to 15% of the axial width of said hooping layer,
the maximum absolute value of said angle being at least equal to the mean of the absolute values of the angles formed by the metal reinforcing elements of said hooping layer with the circumferential direction (XX′) at the two axial ends of said hooping layer, plus 10°.

The solution implemented makes it possible to improve the axial balance of the circumferential stiffness values by maintaining the stiffness in the vicinity of the axial ends of the working layers and reducing it at the center. The inventors started from the observation that the circumferential stiffness values are too high at the center due to the hooping layers. On some tires, the hooping layers are the source of five sevenths of the circumferential stiffness at the center. Counter-intuitively, given the stiffness of the reinforcing elements of the hooping layers, the invention consists in modifying the stiffness of at least one hooping layer at the center and keeping the functioning thereof identical at the axial ends thereof, by modifying the angle at the center formed by the reinforcing elements with the circumferential direction of at least one hooping layer.

The reference civil engineering tires taken into consideration usually have two hooping layers radially inside two working layers, in turn radially inside two protective layers. The hooping layers of the reference civil engineering tires taken into consideration are made up of metal reinforcing elements that are parallel to each other and coated in a rubber composition, extending continuously from one axial end of the hooping layer to the other and forming a substantially constant angle with the circumferential direction, at most equal to 10°, in order to allow effective hooping. The invention consists in modifying the angle of the reinforcing elements of at least one hooping layer, around the center of the tire, so that:
the metal reinforcing elements of at least one hooping layer form an angle with the circumferential direction (XX′) that varies from one axial end of said hooping layer to the other axial end,
the angle formed by the metal reinforcing elements of said hooping layer with the circumferential direction (XX′) having a maximum absolute value (Am) at an axial distance from the median plane at most equal to 15% of the axial width of said hooping layer, the maximum coinciding approximately with the center of the hooping layer in order to reduce the stiffness exactly where this is desired,
the maximum absolute value of said angle being at least equal to the mean of the absolute values of the angles formed by the metal reinforcing elements of said hooping layer with the circumferential direction (XX′) at the two axial ends of said hooping layer, plus 10°.
   On a variable-angle hooping layer, these conditions make it possible to reduce the circumferential stiffness of the crown reinforcement at the center by around 20%. The same modification on two hooping layers allows a 40% reduction in stiffness.

A preferred solution for a tire the crown reinforcement of which comprises at least two hooping layers is thus that the angles formed by the metal reinforcing elements of said at least two hooping layers with the circumferential direction (XX′) are variable from one axial end to the other of each hooping layer, have a maximum absolute value at an axial distance from the median plane at most equal to 15% of the axial width of said hooping layer in question, and that the maximum absolute values of said angles are at least equal to the mean of the absolute values of the angles formed by the metal reinforcing elements of the hooping layer in question with the circumferential direction (XX′) at the two axial ends of said hooping layer, plus 10°. For a tire having two hooping layers, the angles of which are variable, if each maximum absolute value of said angles is at least equal to the mean of the absolute values of the angles formed by the metal reinforcing elements of the hooping layer in question with the circumferential direction (XX′) at the two axial ends of the hooping layer in question plus 16°, the reduction in the total stiffness of the crown reinforcement at the center is at least equal to 50%, and for plus 25° respectively, the reduction in the total stiffness of the crown reinforcement at the center is at least equal to 65%.

Advantageously, the crown reinforcement comprises two hooping layers for reasons of manufacturing cycle times and balance of the crown architecture, the angles formed by the reinforcing elements of the two hooping layers being of opposite signs.

One preferred solution is that the absolute values of the angles (Ae1, Ae2) formed by the metal reinforcing elements of each hooping layer with the circumferential direction (XX′), at the two axial ends, are at least equal to 5°. Below this, the hooping layers are made up of a winding of a reinforcing element or a strip of reinforcing elements, for which it is complicated to vary the angle of the reinforcing elements from one axial end of the hooping layer in question to the other axial end thereof. In this case, there is one end of the reinforcing element at each axial end of the hooping layer in question. For angles at least equal to 5°, the hooping layers are made up of a large number of reinforcing elements distant from the adjacent reinforcing elements by a substantially constant circumferential pitch to within manufacturing tolerances, each reinforcing element having an axial end at each axial end of the hooping layer. In this case, in order to vary the angle of the reinforcing elements from one axial end of the hooping layer to the other, the hooping layers must simply be prepared on a rigid ring for example and rotations must be performed about the axis of rotation of the drum between the central region of the hooping layer and the axial regions, while separating the axial regions from each other.

One advantageous solution for protecting the hooping layers from attack is that each hooping layer is radially inside the working layers.

Preferably, the metal reinforcing elements of the working layers have a tensile modulus at least equal to 150 GPa, which corresponds to inextensible reinforcing elements of the working layers that have excellent endurance performance.

One preferred solution is that the crown reinforcement comprises two protective layers, radially outside the working layers, each comprising metal reinforcing elements coated in an elastomeric material that are parallel to each other, forming an angle at least equal to 15° and at most equal to 45° with the circumferential direction (XX′), said metal reinforcing elements being crossed from one protective layer to the next, and having a tensile modulus at most equal to 150 GPa. The presence of protective layers the reinforcing elements of which are elastic very substantially improves the performance of the civil engineering or heavy-duty tires with respect to puncturing by stones.

Advantageously, in order to protect the ends of the working layers from tramping against the stones on the tracks on which they run, the radially innermost protective layer is the layer of the crown reinforcement having a larger axial width.

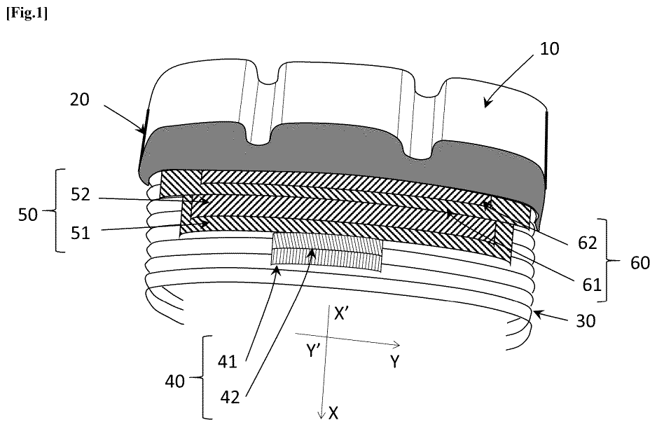

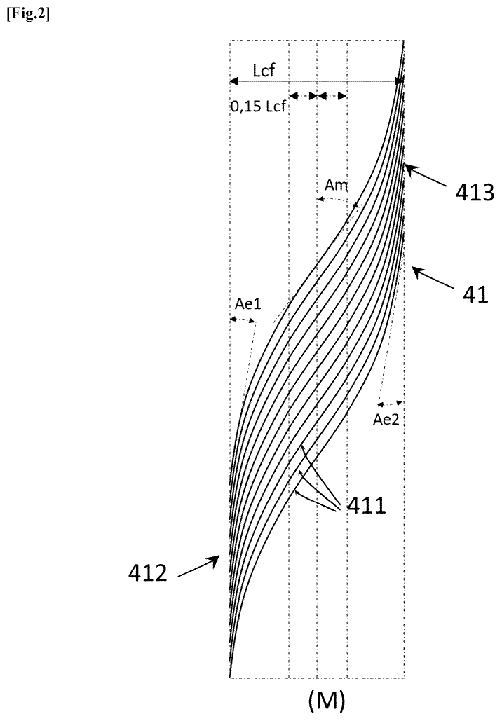

The features of the invention are illustrated in the schematic FIGS. 1 and 2, which are not to scale, with reference to a tire of size 59/80 R63. FIG. 1 shows a meridian cross-section of a civil engineering tire crown, and FIG. 2 shows a portion of a variable-angle hooping layer.

FIG. 1 shows a cutaway perspective view of the crown of a tire having:
a tread 10,
sidewalls 20,
a carcass reinforcement 30 comprising a carcass layer, the reinforcers of which form an angle of close to 90° with the circumferential direction XX′,
a hoop reinforcement 40 comprising two hooping layers 41 and 42,
a working reinforcement 50 comprising two working layers 51 and 52 and radially outside the hoop reinforcement 40,
a protective reinforcement 60 comprising two protective layers 61 and 62.

In the prior art, the angles formed by the reinforcing elements of the different crown layers with the circumferential direction are substantially constant to within manufacturing variations. During the molding of the tire, the reinforcing elements deform and their angles can vary slightly from one axial position to the other. In the tire according to the invention, in at least one hooping layer, the angle formed by the reinforcing elements with the circumferential direction varies from one axial end of the hooping layer in question to the other by at least 10°. For the sake of legibility, this variation is not shown in FIG. 1.

FIG. 2 shows a portion of the variable-angle hooping layer 41 laid flat, having an axial width Lcf comprising reinforcing elements 411 that are parallel to each other, that is, equidistant by a constant circumferential distance to within manufacturing variations. The angles of the reinforcing elements 411 of the hooping layer 41 vary from a value Ae1 at one axial end 412 of the hooping layer 41 to a value Ae2 at the other axial end 413, which are substantially identical here, passing through a maximum value Am in a central region of the hooping layer. This region has an axial width at most equal to 30% of Lcf, the maximum being at most distant from the median plan (M) by an axial distance at most equal to 15% of Lcf. Here, the angles vary from 8° at the axial end of the hooping layer to approximately 37° at the center. Such a variation can be obtained using a hooping layer with a constant angle of 8° to which a relative displacement of one end with respect to the other is applied that is both circumferential and axial.

The angles Ae1, Ae2, and the angles of different crown layers, are measured using methods well known to a person skilled in the art, either using non-destructive testing means or by cutting the tire and accessing the different crown layers. The same applies to measuring the axial widths of the different crown layers, which are usually measured on a meridian cross-section. Unless the axial position of the measurement is specified, as for the variable-angle hooping layers, the measurements of the angles are preferably taken at the center of the crown layer in question—usually at the median plane—or at the center of the axial part in question in order to have a reference value, as the measured angle can vary slightly with the axial position of the measurement.

The invention is compared to a commercially available control tire (Michelin 59/80R63 XDR3 MB4) of the same size, the crown of which is made up of two hooping layers radially inside two working layers radially inside two protective layers. The reinforcing elements of the hooping layers form angles of 8 and −8°. They are 77.35 inextensible elements, that is, made up of 77 steel threads with a diameter of 35 one hundredths of a millimeter, for a tensile modulus measured on a cord extracted from the tire equal to 178 GPa, arranged at a pitch of 6.4 mm. The reinforcing elements of the working layers form angles of −33 and 24°. They are inextensible. The reinforcing elements of the protective layers are extensible and form angles of −33 and 33°.

The control tires and the tires according to the invention are identical apart from the hooping layers. They have the same tread pattern and the same reinforcers for the carcass layer, the protective layers and the working layers, and the same rubber compounds for the different parts of the tire.

The invention was simulated on computational tools. The simulations make it possible to evaluate the mechanical and thermal stresses on tires using the large displacement and large deformation finite elements method, taking into account the mechanical and hysteretic characteristics of the materials.

The aim of the invention is to reduce the circumferential stiffness at the center in order to improve wear, attack and puncture resistance. The reduction in stiffness is estimated on the basis of the deformation of the crown block under the effect of a pressure increase. The two hooping layers have variable angles, the angles at the axial ends of the hooping layers having an absolute value equal to 8°, like the reference tires. The stiffness at the center of the crown is divided by a factor of 3.3 when the absolute value of the maximum angle at the center of the hooping layers is equal to 33, divided by 2.3 when the absolute value of the maximum angle at the center of the hooping layers is equal to 24, and divided by 1.4 when the absolute value of the maximum angle at the center of the hooping layers is equal to 18. The stiffness at the ends of the crown layers is kept at the same value as for the reference tires. The mean stiffness of the crown reinforcement is sufficient to absorb the running forces. This reduction in stiffness at the center should allow an increase in puncture resistance of the invention of between 20% and 40% depending on the maximum angles at the center of the hooping layers and the stiffness reduction selected, and should help to overcome problems of uneven wear due to the excessive stiffness of the center of the control civil engineering tire.

With respect to the endurance of the crown, the safety factors (breaking strength of the cord on maximum stress) of the reinforcing elements of all of the crown layers are at least equal to the minimum safety factor of the control tire. Likewise, the stresses of the rubber compositions at the ends of the working layers are substantially identical due to the axial parts of the hooping layers. From this point of view, the inventors expect at least the same endurance performance as the control tire. The masses of the control tire and the tire according to the invention are equivalent.

All of these performance aspects demonstrate the benefit of the invention.

1. A radial tire for a heavy-duty or civil engineering vehicle comprising
a crown reinforcement, radially inside a tread and radially outside a carcass reinforcement,
a median plane (M) perpendicular to the axis of rotation of the tire and passing through the middle of the tread,
the crown reinforcement comprising a working reinforcement,
the working reinforcement comprising at least two working layers, each comprising metal reinforcing elements coated in an elastomeric material that are parallel to each other, forming an angle at least equal to 15° and at most equal to 45° with the circumferential direction (XX′), said metal reinforcing elements being crossed from one working layer to the next,
the crown reinforcement comprising a hoop reinforcement comprising at least one hooping layer, each hooping layer comprising metal reinforcing elements coated in an elastomeric material, parallel to each other and comprising two axial ends on either side of the median plane (M),
the reinforcing elements of each hooping layer forming, at the two axial ends thereof, angles (Ae1, Ae2) of the same orientation and having absolute values at most equal to 10° with the circumferential direction,
wherein the angle formed by the metal reinforcing elements of a hooping layer with the circumferential direction (XX′) is variable from one axial end of said hooping layer to the other axial end, and has a maximum absolute value (Am) at an axial distance from the median plane (M) at most equal to 15% of the axial width of said hooping layer, and
wherein the maximum absolute value (Am) of said angle is at least equal to the mean of the absolute values of the angles (Ae1, Ae2) formed by the metal reinforcing elements of said hooping layer with the circumferential direction (XX′) at the two axial ends of said hooping layer plus 10°.

2. The tire as claimed in claim 1, wherein the crown reinforcement comprises at least two hooping layers, the angles formed by the metal reinforcing elements of said at least two hooping layers with the circumferential direction (XX′) being variable from one axial end to the other of each hooping layer, having a maximum absolute value (Am) at an axial distance from the median plane (M) at most equal to 15% of the axial width of said hooping layer in question, the maximum absolute values (Am) of said angles being at least equal to the mean of the absolute values of the angles (Ae1, Ae2) formed by the metal reinforcing elements of the hooping layer in question with the circumferential direction (XX′) at the two axial ends of said hooping layer, plus 10°.

3. The tire as claimed in claim 1, wherein the crown reinforcement comprises two hooping layers.

4. The tire as claimed in 1, wherein the absolute values of the angles (Ae1, Ae2) formed by the metal reinforcing elements of each hooping layer with the circumferential direction (XX′), at the two axial ends, are at least equal to 5°.

5. The tire as claimed in claim 1, wherein each hooping layer is radially inside the working layers.

6. The tire as claimed in claim 1, wherein the metal reinforcing elements of the working layers have a tensile modulus at least equal to 150 GPa.

7. The tire as claimed in claim 1, wherein the crown reinforcement comprises two protective layers, radially outside the working layers, each comprising metal reinforcing elements coated in an elastomeric material that are parallel to each other, forming an angle at least equal to 15° and at most equal to 45° with the circumferential direction (XX′), said metal reinforcing elements being crossed from one protective layer to the next, and having a tensile modulus at most equal to 150 GPa.

8. The tire as claimed in claim 7, wherein the radially innermost protective layer is the layer of the crown reinforcement having a larger axial width.
